(19) United States
(12) Patent Application Publication
(10) Pub. No.: US 2002/0108126 A1
(43) Pub. Date: Aug. 8, 2002

(54) Background enabled recording in a set top box

(76) Inventors: Steven M. Horowitz, Los Altos, CA (US); Geoffrey R. Smith, Mountain View, CA (US); Peter J. Potrebic, Calistoga, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/779,869

(22) Filed: Feb. 8, 2001

(51) Int. Cl. H04N 7/173; H04N 7/16

(52) U.S. Cl. 725/141; 725/131; 725/153

(57) ABSTRACT

Systems and methods for recording a channel included in programming content without degrading or lessening the quality of the channel. Programming content is received at a set top box where a tuner is used to tune a group of channels included in the programming content. A transport is used to demultiplex the group of channels such that the channel to be recorded is produced. Instead of being decoded, the channel is directed to a storage medium where it is recorded in a digital form. The channel is not degraded because it has not been converted to an analog equivalent and re-encoded. The channel is stored as it was received by the tuner. Because the tuner may be used to record a channel, the set top box may either display the channel being recorded by simultaneously decoding the channel or the set top box has the option of retrieving a previously recorded channel that is subsequently decoded and displayed to a user.

### BACKGROUND OF THE INVENTION

1. The Field of the Invention

The present invention relates to systems and methods for recording digital programming content included in a video stream or channel. More specifically, the present invention relates to systems and methods for recording a video stream or channel without degrading the quality of the video stream or channel at a set top box having at least one tuner.

2. The Prior State of the Art

Set top boxes, such as cable boxes and satellite receivers, are becoming increasingly prevalent in consumer's homes because they often provide a consumer with the ability to choose from a growing number of channels. Because the consumer has a great number of channels from which to choose, the consumer often has a desire to record a program on one of the channels for later viewing. As a result, many set top boxes have begun to resemble computers by providing a storage medium to the consumer such that the consumer may select and record programs that are received through set top boxes.

Recording a program usually results in a recording that is of lesser quality than the original program because the original program received by the set top box is decoded and re-encoded before it is actually recorded. This is because the digital transmission received by the set top box must be processed before a particular program or channel can be viewed or recorded. When the digital transmission is first received at the set top box, it must first be tuned to a particular transport stream. The transport stream contains multiple video streams, each of which corresponds to a particular channel. Thus, the transport stream is demultiplexed to isolate or identify a single video stream. The demultiplexed video stream contains related audio, video and data packets, which may be encrypted.

After the relevant video, audio and data packets for a particular channel have been separated from the transport stream, a conditional access system determines whether or not a consumer is authorized to access or display the demultiplexed channel. If the consumer has authorized access to the channel, the affected packets are decrypted. Next, the decrypted audio and video packets are decoded to produce video and audio outputs that may be interpreted by a user device such as a television. Obviously, the conditional access system does not operate when the demultiplexed channel or video stream is not encrypted.

In either case, the audio and video outputs of the satellite receiver provide the consumer with access to the program that is to be recorded. Unfortunately, the audio and video outputs of the satellite receiver are usually of an analog nature and cannot be recorded digitally. To record a particular video stream or channel, a digital video recorder or other recording device is often used in conjunction with a satellite receiver. The analog inputs to the digital video recorder can be provided from a number of different sources including satellite receivers and cable boxes. In each of these cases however, the analog programming signal received by the digital video recorder is an analog version of the original digital programming signal. The conversion of the original digital programming signal to an analog programming signal introduces errors that can significantly lessen the quality of the digital recording that is ultimately stored on the digital video recorder. Because the signal received by the digital video recorder is an analog signal, it must be encoded before it may be digitally recorded, a process that also introduces additional error and degradation into the stored version of the original digital signal.

For example, FIG. 1 illustrates a conventional satellite receiver 110 connected with a digital video recorder 150 and illustrates how the quality of a video stream is degraded. The programming content 212 is received at the satellite receiver 110 where it is tuned and demodulated by a tuner 114 and a demodulator 116 to produce a transport stream. The transport demultiplexor 118 demultiplexes the transport stream to produce a video stream that is decoded by the decoder 122 to produce the audio outputs 126 and video output 124, which are analog signals.

The analog audio outputs 126 and video output 124 are received at the digital video recorder 150 and converted back to a digital signal by digitizer 152. The re-digitized signals have to be re-encoded by the encoder 154 to reproduce the original video stream output by the transport demultiplexor 118. Unfortunately, the video stream output by the encoder 154 has been degraded by the re-digitizing and re-encoding processes. This degraded video stream may be recorded on the storage 156 as a recording 157. The recording 157 can be decoded by the decoder 158 to produce audio outputs 160 and video output 162, which are rendered, for example, by a television. Again, the audio outputs 160 and the video output 162 are of lesser quality than the audio outputs 126 and the video output 124 because the original video stream generated by the transport demultiplexor 118 had to be re-digitized and re-encoded in order to be recorded on the storage 156.

### SUMMARY OF THE INVENTION

The present invention relates to systems and methods for recording programming content. The present invention also relates to an integrated architecture that permits programming content to be recorded without a corresponding loss of quality in the recorded programming content. Most set top boxes that receive digital programming content, such as satellite receivers, have a single digital tuner. One feature of the present invention is the ability to decouple the tuner such that the digital programming content may be stored on a storage medium such as a hard drive or other computer-readable medium.

When the tuner is being used to record the digital programming content, the user is not able to tune other channels that may be included in the programming content. However, the user has the option of viewing the channel that is being recorded or the user may view another program or channel that has already been stored or recorded on the storage medium. In this manner, the present invention enables one channel to be recorded while previously recorded programming content is viewed in a single tuner environment.

Decoupling the tuner in this manner also provides other advantages. For example, the present invention provides systems and methods for recording the digital programming content before the programming content is decoded. More specifically, the programming content may be recorded as it was received from the programming content provider without degrading the original video stream.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the above recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 represents a prior art system for recording programming content and illustrate the degradation of a video stream;

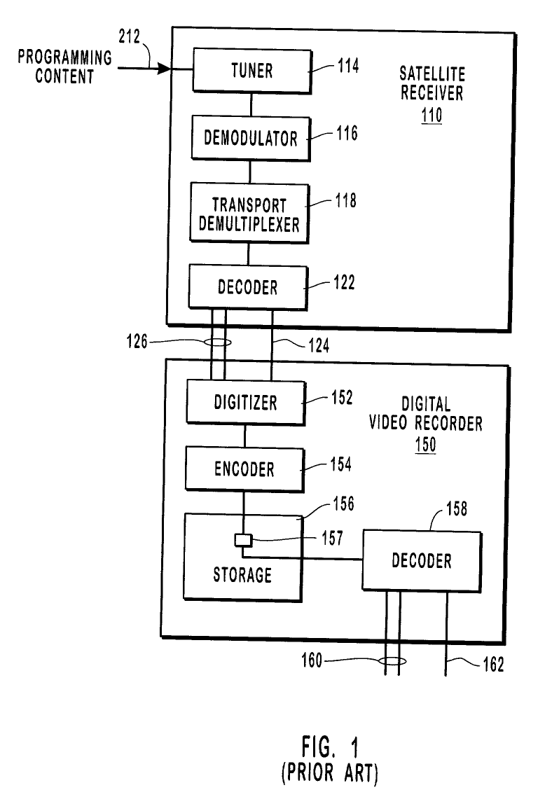

FIG. 2 illustrates an exemplary system that provides a suitable operating environment for the present invention;

FIG. 3 illustrates a satellite system that transmits programming content from a content provider to a set top box via a satellite; and

FIG. 4 illustrates an exemplary set top box including a tuner whereby the programming content may be recorded on a storage medium without degrading the programming content.

### DETAILED DESCRIPTION OF THE INVENTION

The present invention relates to recording digital programming content. In one embodiment, the programming content is recorded in the background. In other words, the tuner is effectively decoupled in a manner that permits the programming content to be background recorded while the set top box displays other digital programming content. The present invention also addresses the need of being able to record digital programming content without degrading or lowering the quality of the digital programming content. Degrading the quality of the digital programming content is avoided by storing the digital programming content before it is decoded and converted to an analog signal. By avoiding these procedures, which lower the quality of the programming content each time the programming content is encoded and decoded, the original quality of the programming content can be maintained when the recorded programming content is viewed by a user.

The present invention extends to both systems and methods for recording digital programming content without degrading the programming content. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. One example of a special purpose computer is a set top box. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions

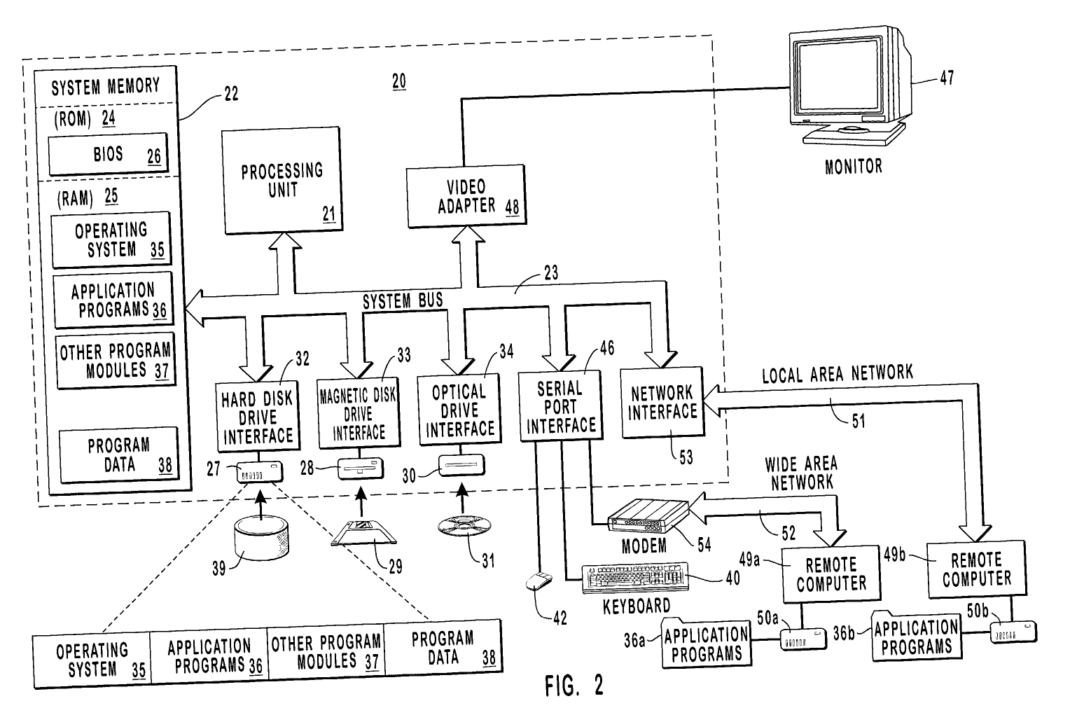

FIG. 2 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including set top boxes, personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 2, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 2. The logical connections depicted in FIG. 2 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

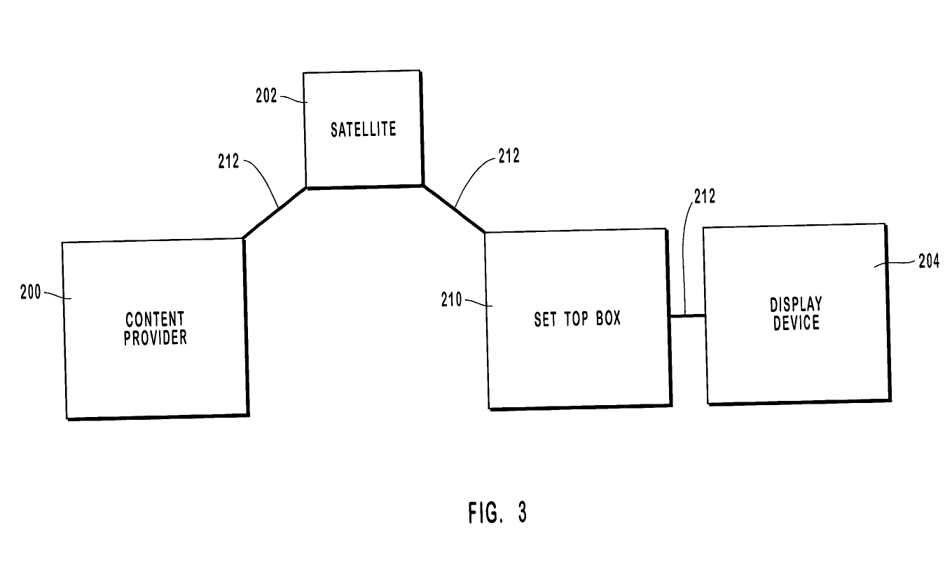

FIG. 3 is a block diagram that generally illustrates the transmission of programming content to a set top box. The programming content 212 is representative of the data, information or signals that are received by the set top box 210, and may include, but is not limited to, satellite transmissions, cable television transmissions, local television transmissions, radio transmissions, Internet data or transmissions, Motion Pictures Experts Group (MPEG) video, video streams, audio streams, and the like or any combination thereof whether analog or digital in nature. Programming content 212 also includes the content carried by satellite transmissions, cable transmissions, radio transmissions, local television transmissions and the like or any combination thereof.

Included in the programming content 212 is electronic program guide (EPG) data, also referred to herein as “guide data.” The guide data is usually a description of the programming content 212 and may include, but is not limited to, program titles, program starting times, program ending times, program ratings, program descriptions, program content ratings, program duration, program reviews, and the like or any combination thereof. More generally, the guide data, as used herein, refers to data or information that is related to or describes the programming content 212. The guide data is usually processed by the set top box 210 and displayed to a user via the display 204, which may be a television set, a computer monitor, or other display device.

Often, the programming content 212 contains multiple channels, each of which may carry a different kind of data. For instance, one channel may carry MPEG video streams while another channel may carry Internet related data. In most instances, the programming content 212 is compressed.

The content provider 200 transmits the programming content 212 to a satellite 202. Each satellite 202 typically has 32 broadcast frequencies or transponders and the number of channels that can be compressed onto each transponder of the satellite 202 is dependent on many factors including, but not limited to, the image quality, the frame rate of the source material, the amount of movement in the source material, the amount of error correction overhead, and the like. Generally, each transponder can carry approximately 7 to 12 channels. In addition to carrying multiple channels, the programming content broadcast by each transponder often includes program guide data, conditional access data, and other digital information.

The programming content broadcast by the satellite 202 is received at the set top box 210 and processed such that the data or channels may be viewed on the display device 204. Because multiple channels can be carried on a single transponder and each satellite has multiple transponders, the antenna for the set top box 210 is capable of receiving on the order of 300 channels while being pointed at a fixed position or satellite 202. While the present invention is described in terms of programming content delivered via a satellite system, it is understood that the systems and methods described herein may be applied to cable television systems, the Internet, and other systems capable of delivering programming content to a user.

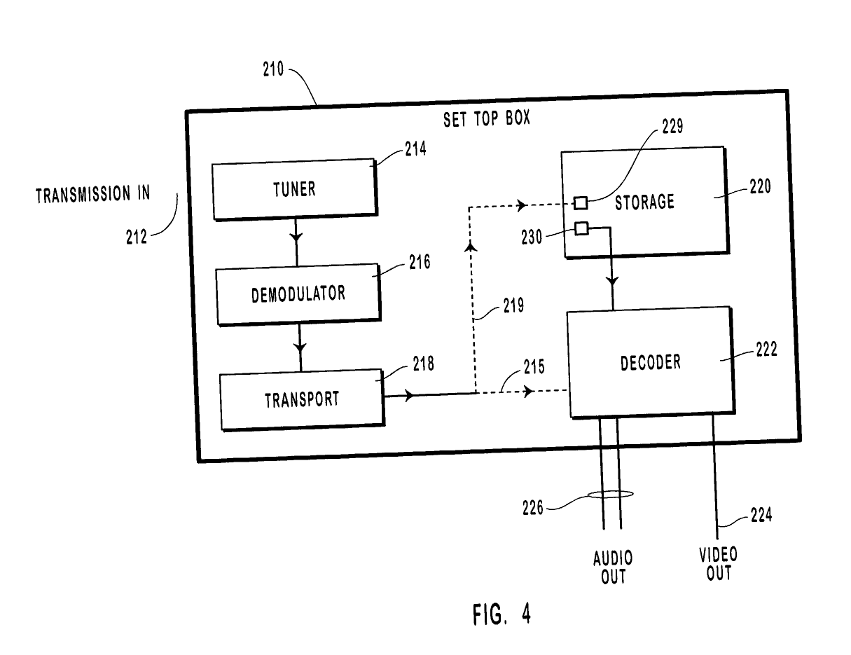

FIG. 4 is a block diagram illustrating an exemplary set top box, which represents one example of a special purpose computer that can implement the invention. The set top box 210 is representative of analog and digital devices including, but not limited to, satellite receivers, digital recording devices, cable boxes, video game consoles, Internet access boxes, and the like or any combination thereof, all of which are examples of special purpose computers. Television sets integrated with set top boxes are also embraced by the term “set top box.” The set top box 210 typically includes portions of the general purpose computer as described with reference to FIG. 2. Additionally, the set top box 202 can be, but does not need to be, capable of connecting with a network such as the Internet.

The set top box 210 typically has several components that act on the programming content 212 in order to produce or display a channel on the display 204 or otherwise render at least a portion of the programming content 212. The programming content 212 received by the set top box 210, as illustrated in FIG. 4, is typically received from a satellite as illustrated in FIG. 3, Upon receiving the programming content 212, the set top box 210 tunes to a particular transponder of the satellite using the tuner 214.

Next, the demodulator 216 demodulates the tuned signal and the output of the demodulator 216 is a multiplexed transport stream. The output of the tuner 214 and the demodulator 216 contains audio, video, and data packets which may be associated with multiple channels, guide data, conditional access data, and the like. In order to separate a particular channel from the transport stream, the transport 218 demultiplexes the transport stream produced by the tuner 214 and the demodulator 216 to isolate a particular video stream or channel included in the multiplexed transport stream.

In order to view or render the video stream output by the transport 218 without recording the video stream, the video stream is received by the decoder 222, which demultiplexes the video, audio, and other information in the transport output. From the demultiplexed video, video frames are generated and output to the video out 224 in their proper order. The audio output, which is generated from the demultiplexed audio, is supplied at the audio outputs 226. These analog outputs are typically supplied to a display device or other set top box.

As described with reference to FIG. 3, the analog video out 224 and the analog audio outputs 226 can be digitally recorded, they must first be re-digitized or converted to a digital signal using an analog to digital converter and encoded. As previously described, this results in a degradation of the original digital video stream. In the set top box 210 shown in FIG. 4, this degradation of the video stream is avoided because the output of the transport 218 is directed to the storage medium 220 and recorded in an encoded digital format on the storage medium 220 as indicated by the dashed line 219. The storage medium 220 may be a hard drive or other computer readable medium as described with reference to FIG. 2. Because the video stream or channel is digitally recorded as it was received at the set top box, the encoded digital format may be determined from the content provider.

A video stream or channel recorded in this manner is designated in FIG. 4 as recording 229. The recording 229 has not been decoded or converted to an analog form and is therefore stored on the storage medium 220 as it was received in the programming content 212 at the input of the set top box 210. The recording 229 does not suffer from degradation that is introduced when the channel is converted to an analog signal and re-encoded.

The recording 229, when stored from the output of the transport 218, is a digital recording of the program selected by the user, has not typically been converted to an analog signal, and has not been decoded. When the user decides to view the program stored as the recording 229, which was stored from the output of the transport 218, the recording 229 is simply decoded by the decoder 222 to generate the audio and video outputs.

As indicated by the dashed lines 219 and 215, the output of the transport 218 can be directed to the storage 220 and/or the decoder 222. Thus, the transport 218 is effectively decoupled from the decoder 222 when the output of the transport 218 is directed to the storage 220. More generally, the tuner 214 is also decoupled from the decoder 222 because the transport stream tuned by the tuner 214 is not being viewed in this example, and it is possible to view a previously recorded channel while the set top box 210 is recording another channel. For example, the tuner 214 may be used such that a first video stream may be stored as recording 229, while a second video stream from the recording 230, which was previously recorded, may be decoded by the decoder 222 and presented to a user on a suitable device. It is important to understand that the recording 230 was recorded without decoding the recording 230 in order to minimize the degradation of the recording 230. The recording 230 was also recorded from the output of the transport 218 as described above. In this manner, a channel may be recorded while another channel is viewed in a set top box that only has a single tuner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system having a set top box receiving programming content and a display device for displaying the programming content, a method for recording a first stream included in the programming content while displaying a second stream on the display device, the method comprising the acts of:
receiving the programming content at the set top box;
tuning the first stream from the programming content with a tuner;
storing the first stream on a storage medium at the set top box without degrading the first stream; and
displaying a second stream on the display device without using the tuner, wherein the second stream is retrieved from the storage medium.

2. A method as defined in claim 1, wherein the act of tuning further comprises the act of demodulating the first stream.

3. A method as defined in claim 2, wherein the act of tuning further comprises the act of demultiplexing the first stream to produce a channel.

4. A method as defined in claim 1, wherein the act of storing the first stream further comprises the act of storing a channel included in the first stream.

5. A method as defined in claim 1, wherein the act of displaying a second stream further comprises the act of decoding the second stream.

6. A method as defined in claim 1, wherein the second stream comprises a channel that has been previously tuned by the tuner and stored on the storage medium.

7. A method as defined in claim 1, wherein the first stream comprises a digital channel.

8. A method as defined in claim 7, wherein the act of storing the digital channel is conducted without performing any digital to analog conversion on the digital channel prior to storing the digital channel on the storage medium.

9. A method as defined in claim 1, wherein the programming content is received from a transponder on a satellite.

10. In a system receiving digital programming content including a plurality of channels, a method for recording a channel included in the plurality of channels without degrading the channel, the method comprising the acts of:
tuning and demodulating the programming content to identify the plurality of channels;
demultiplexing the plurality of channels to select the channel, wherein the channel is digitally encoded; and
recording the channel on a storage medium without decoding the channel such that the recorded channel is not degraded.

11. A method as defined in claim 10, wherein the act of tuning and demodulating further comprises the act of selecting, by a user, the channel to be recorded.

12. A method as defined in claim 10, wherein the channel is compressed.

13. A method as defined in claim 10, wherein the act of recording the channel further comprises the act of simultaneously displaying the channel on a display device.

14. A method as defined in claim 13, wherein the act of displaying the channel further comprises the act of decoding the channel with a decoder, wherein the decoder produces video output and audio outputs.

15. A method as defined in claim 10, further comprising the acts of:
decoding a second channel already recorded on the storage medium while the channel is recording on the storage medium; and
displaying the second channel, wherein the second channel is not tuned by the system when the second channel is displayed.

16. A method as defined in claim 10, wherein the programming content is tuned and demodulated in a set top box having a tuner and a demodulator, wherein the programming content is received from a transponder of a satellite.

17. In a system receiving programming content from a programming content provider, a device for recording a selected channel included in the programming content without degrading the selected channel, the device comprising:
a tuner that tunes the programming content to a plurality of channels included in the programming content;
a demodulator that demodulates the plurality of channels tuned by the tuner;
a transport, wherein the transport receives the plurality of channels demodulated by the demodulator and demultiplexes the plurality of channels to produce the selected channel at a transport output that is connected to a decoder, wherein the transport output can be selectively decoupled from the decoder; and
a storage medium for receiving and recording the selected channel when the transport is decoupled from the decoder such that the selected channel is recorded on the storage medium without degrading the selected channel.

18. A device as defined in claim 17, wherein the selected channel being recorded is included in the plurality of channels tuned by the tuner.

19. A device as defined in claim 17, wherein the decoder is connected to the storage medium such that a recorded channel may be decoded and displayed on a display device while the selected channel is recorded on the storage medium.

20. A device as defined in claim 17, wherein the transport simultaneously directs the selected channel to both the storage medium and the decoder.

21. A device as defined in claim 17, further comprising a conditional access system, the conditional access system determining whether the device may display the selected channel.
